(19) United States
(12) Patent Application Publication
(10) Pub. No.: US 2021/0344072 A1
(43) Pub. Date: Nov. 4, 2021

(54) BATTERY HOUSING AND METHOD FOR PRODUCING A BATTERY HOUSING

(71) Applicant: Mahle International GmbH, Stuttgart (DE)

(72) Inventors: Heiko Neff, Auenwald (DE); Johannes Weinmann, Stuttgart (DE)

(21) Appl. No.: 17/243,560

(22) Filed: Apr. 28, 2021

(30) Foreign Application Priority Data
Apr. 29, 2020 (DE) 102020205426.6

(51) Int. Cl. H01M 50/209; H01M 50/229; B29C 69/02

(52) U.S. Cl. CPC H01M 50/209; B29L 2031/3481; B29C 69/02; H01M 50/229

(57) ABSTRACT

The invention relates to a battery housing (1) for an electrical battery, comprising a basic body (2) which extends in a direction of extent (E) and at least partially delimits a housing interior space (3) on the inside. The battery housing (1) moreover comprises at least one stiffening rib (4), which is shaped integrally on the inside or the outside of the basic body (2) and protrudes from the basic body (2). The stiffening rib (4) of the battery housing (1) runs on the basic body (2) in a rib direction (R) oriented at an angle to the direction of extent (E). In this respect, a body material of the basic body (2) comprises first reinforcing fibres (5), which run substantially in the direction of extent (E) and a rib material of the stiffening rib (4) comprises second reinforcing fibres (6), which run substantially in the rib direction (R).

The invention relates to a battery housing for an electrical battery, and to a method for producing such a battery housing.

Electrical batteries for motor vehicles, that is to say electrical batteries for providing electrical energy for an electric drive train of the motor vehicle, typically comprise a battery housing which delimits a housing interior space. In this housing interior space of the battery housing, conventional electrical components of the battery are arranged and electrically insulated by means of the battery housing with respect to the external surroundings and mechanically protected against ambient influences. Here, it is possible that in the housing interior space there is an internal pressure which is greater than that of the external surroundings and to which the battery housing has to be designed as resistant.

Against this background, plastic battery housings which are provided with stiffening ribs have been used for some time. Such battery housings are typically produced in a single injection moulding operation, in which the respective battery housing is subjected to primary forming together with the stiffening ribs. In the process, it is conventional to injection mould such battery housings with a fibre-filled plastics material. The fibres, which are embedded in the plastics material during the injection moulding, increase a compressive strength of the battery housing. However, the one-stage injection moulding of such conventional battery housings inevitably has the consequence that the fibres incorporated in the plastic are oriented substantially along a common fibre direction over the entire battery housing, that is to say also in the stiffening ribs. Although this improves the ability of the battery housing to bear high loads in the fibre direction, it is possible that the fibres display no reinforcing action or scarcely any reinforcing action transverse to the fibre direction. Mechanical stresses, which are formed as a result of the loading of the battery housing due to the elevated internal pressure present in the housing interior space, typically however run not exclusively in the fibre direction, but also transversely thereto. Correspondingly, such conventional battery housings are to be considered problematic in terms of their compressive strength.

It is therefore an object of the present invention to demonstrate new approaches in respect of battery housings for an electrical battery and also in respect of methods for producing a battery housing—in particular to eliminate the disadvantages identified above.

Said object is achieved by the battery housing according to independent Patent claim 1 and also by the method for producing a battery housing according to independent Patent claim 11. Preferred embodiments are the subject matter of the dependent patent claims.

The basic concept of the invention is accordingly to configure a battery housing for an electrical battery such that the body material of a basic body of the battery housing comprises first reinforcing fibres which run substantially in a direction of extent of the basic body, and in which a rib material of a stiffening rib shaped on the basic body comprises second reinforcing fibres which run substantially in a rib direction. along which the stiffening rib extends. In this case, the direction of extent and the rib direction are oriented at an angle to one another according to the invention, with the result that the first reinforcing fibres of the body material of the basic body run at an angle to the second reinforcing fibres of the rib material of the stiffening rib.

Advantageously, such a battery housing is particularly pressure-resistant, since the fibres—contrary to conventional housing parts—are oriented not solely in a common fibre direction, but rather that part of the fibres which is incorporated in the basic body runs in a first fibre direction determined by the direction of extent of the basic body and that portion of the fibres which is incorporated in the stiffening rib runs in a second fibre direction determined by the rib direction, the two fibre directions being different from one another. The fibres thus have a reinforcing action in different directions, thereby bringing about the desired increase in the compressive strength of the battery housing.

A battery housing according to the invention for an electrical battery, which is preferably part of a motor vehicle and which particularly preferably serves to provide electrical energy or electrical power for an electric drive train of the motor vehicle, comprises a basic body which extends in a direction of extent. The direction of extent preferably corresponds to a longitudinal direction in which the basic body extends. The basic body of the battery housing at least partially delimits a housing interior space on the inside. Expediently, electrical components of the electrical battery, such as battery cells or electrical lines, can be accommodated in this housing interior space of the battery housing. The battery housing moreover comprises at least one stiffening rib, which is integrally shaped on the inside or the outside of the basic body of the battery housing. The at least one stiffening rib, which is integrally shaped on the inside or the outside of the basic body, protrudes from the basic body. The at least one stiffening rib runs on the basic body in a rib direction extending at an angle to the direction of extent of the basic body. Here, a body material of the basic body comprises first reinforcing fibres, which run substantially in the direction of extent of the basic body. A rib material of the stiffening ribs comprises second reinforcing fibres, which run substantially in the rib direction. This means that the first reinforcing fibres of the body material of the basic body are oriented at an angle to the second reinforcing fibres of the rib material of the stiffening rib. Such a battery housing is—as already stated above—particularly pressure-resistant with respect to an internal pressure prevailing in the housing interior space.

In a preferred refinement of the battery housing, the rib direction of the at least one stiffening rib and the direction of extent of the basic body run perpendicular to one another. The first reinforcing fibres of the body material of the basic body and the second reinforcing fibres of the rib material of the stiffening rib are thus likewise oriented perpendicular to one another. A particularly good compressive strength of the battery housing can be achieved in this way.

According to a further preferred refinement of the battery housing, the battery housing comprises a plurality of stiffening ribs, which are integrally shaped spaced apart from one another on the basic body. Expediently, the plurality of stiffening ribs are integrally shaped on the inside and—as an alternative or in addition—on the outside of the basic body in a manner spaced apart from one another. This means that stiffening ribs can be integrally shaped both on the inside and on the outside of the basic body, or only on the outside or the inside. Such a plurality of stiffening ribs advantageously increases the mechanical stiffness of the battery housing and thus also, desirably, the compressive strength of the battery housing.

A further advantageous refinement of the battery housing provides that the body material of the basic body comprises a first plastic matrix, in which the first fibres are embedded. The rib material of the at least one stiffening rib comprises a second plastic matrix, in which the second fibres are embedded. The first and the second plastic matrix each comprise a plastic. The first and the second plastic matrix preferably each comprise the same plastic. Such a battery housing can be produced particularly easily.

According to a further preferred refinement of the battery housing, the first plastic matrix comprises a thermoplastic or consists of a thermoplastic. As an alternative or in addition, the second plastic matrix comprises a thermoplastic or consists of a thermoplastic. The thermoplastic may form the plastic of the first and/or the second plastic matrix or be comprised by the plastic. This allows particularly cost-effective production by means of an injection moulding process, which in particular has two stages.

In a further preferred refinement of the battery housing, the first fibres comprise glass fibres or carbon fibres or consist of glass fibres or carbon fibres. As an alternative or in addition, the second fibres comprise glass fibres or carbon fibres or consist of glass fibres or carbon fibres. Such first and/or second fibres are particularly strong, and therefore a particularly pressure-resistant battery housing can be obtained.

In a further preferred refinement of the battery housing, the first fibres have a fibre length of 0.05 mm to 100 mm, preferably of 1 mm to 10 mm, most preferably of 10 mm to 100 mm, measured in the direction of extent of the basic body. As an alternative or in addition, the second fibres have a fibre length of 0.1 mm to 0.9 mm, measured in the rib direction of the at least one stiffening rib. Plastics materials filled with fibres of this type can be processed particularly well by means of an injection moulding process.

A further advantageous refinement of the battery housing provides that the first fibres have a diameter of 9 μm to 15 μm, measured perpendicular to the direction of extent of the basic body. As an alternative or in addition, the second fibres have a diameter of 9 μm to 15 μm, measured perpendicular to the rib direction of the at least one stiffening rib. This has an advantageous effect on the strength of the fibres per se and thus also on the compressive strength of the battery housing.

According to a further preferred refinement of the battery housing, the basic body completely surrounds the housing interior space in a section perpendicular to the direction of extent of the basic body. In this respect, the stiffening rib is shaped preferably around the complete periphery of the basic body in the section perpendicular to the direction of extent. Advantageously, it is thus possible for the housing interior space to be delimited by means of the battery housing in a pressure-tight manner without joints which run in the direction of extent. Mechanical weak points caused by such joints are thus advantageously avoided. By virtue of the joint-free configuration, the housing realized in this way is also fluid-tight already without additional sealing, this resulting in cost advantages.

Expediently, the basic body of the battery housing has a profile which is extruded or pultruded in the direction of extent of the basic body and is particularly expediently a rectangular hollow profile. Such a basic body can be produced particularly cost-effectively, in particular by means of extruding or pultruding.

The invention moreover relates to a method for producing a battery housing, which is preferably a battery housing according to the invention as per the description above. The method comprises a measure a), in which a body raw material comprising first fibres is extruded, in particular pultruded, in a direction of extent. This direction of extent preferably corresponds to a longitudinal direction in which the body raw material is extruded. Here, in measure a), the body raw material comprising the first fibres is extruded in the direction of extent or longitudinal direction in such a way that a basic body of the battery housing that extends in the direction of extent or longitudinal direction is created. This basic body of the battery housing at least partially delimits a housing interior space of the battery housing on the inside. The method moreover comprises a measure b), in which a rib raw material comprising second fibres is moulded onto the basic body. Here, in measure b), the rib raw material is moulded onto the basic body in such a way that at least one stiffening rib which runs in a rib direction oriented at an angle to the direction of extent is integrally shaped on the inside or the outside of the basic body. A materially bonded and/or form-fitting connection of the stiffening rib to the basic body preferably occurs in the process. The body raw material is expediently a plastic filled with the first fibres and the rib raw material is a plastic filled with the second fibres. This allows a particularly simple option for creating the advantageous bidirectional alignment—as already identified above—of the first and/or second fibres.

It is expediently also possible, in measure b), in addition to the moulding on of the ribs, for the housing interior space of the battery housing to be closed in a fluid-tight manner in the direction of extent of one end by moulding a cover onto the end face. This means that, after carrying out measure b), the housing interior space remains in fluidic communication only via a single opening on the end face of the battery housing, which opening is opposite the moulded-on cover with respect to the direction of extent. This remaining opening can be closed by means of a cap which can be fastened to the battery housing, it being possible for any housing-side fastening geometries, such as a sealing flange, screwing points, or the like, which are required for this purpose to be created likewise in measure b). This considerably reduces an assembly outlay.

In a preferred refinement of the method, in measure a) the first fibres are aligned substantially in the direction of extent of the basic body when the body raw material is being extruded, with the result that the first fibres in a body material of the basic body that comprises the first fibres—that is to say after carrying out measure a)—are arranged running substantially in the direction of extent. Moreover, in measure b), the second fibres are aligned substantially in the rib direction of the at least one stiffening rib when the rib raw material is being moulded onto the basic body, with the result that the second fibres in a rib material of the stiffening rib that comprises the second fibres—that is to say after carrying out measure b)—are arranged running substantially in the rib direction of the stiffening rib. This has an advantageous effect on the compressive strength of the housing part created by means of the method.

A further advantageous refinement of the method provides that the stiffening ribs are moulded on according to measure b) in an injection mould, in which the basic body of the housing part that was created in measure a) is placed at a time before carrying out measure b). The stiffening rib can thus be shaped particularly well and positionally accurately on the basic body.

In a further preferred refinement of the method, the basic body of the battery housing that was created in measure a) has a rectangular hollow profile which is extruded in the direction of extent. In this respect, a parting plane of the injection mould, in which the stiffening rib is moulded on according to measure b), is determined by a diagonal of the rectangular hollow profile. This advantageously ensures a particularly good demouldability of the battery housing after the at least one stiffening rib has been moulded onto the basic body.

In measure b), a plurality of stiffening ribs are expediently shaped on the inside and/or the outside of the basic body. Said plurality of stiffening ribs are preferably shaped on the inside and/or the outside of the basic body in a manner spaced apart from one another in the direction of extent of the basic body. This means that stiffening ribs can be shaped both on the inside and on the outside of the basic body, or else only on the inside or the outside.

Further important features and advantages of the invention will emerge from the dependent claims, from the drawings and from the associated description of the figures with reference to the drawings.

It goes without saying that the features mentioned above and those still to be explained below may be used not only in the respectively specified combination but also in other combinations or on their own without departing from the scope of the present invention.

Preferred exemplary embodiments of the invention are shown in the drawings and will be explained in greater detail in the following description, with identical reference signs relating to identical or similar or functionally identical components.

In the figures, in each case schematically:

FIG. 1 shows a perspective illustration of an example of a battery housing according to the invention for an electrical battery,

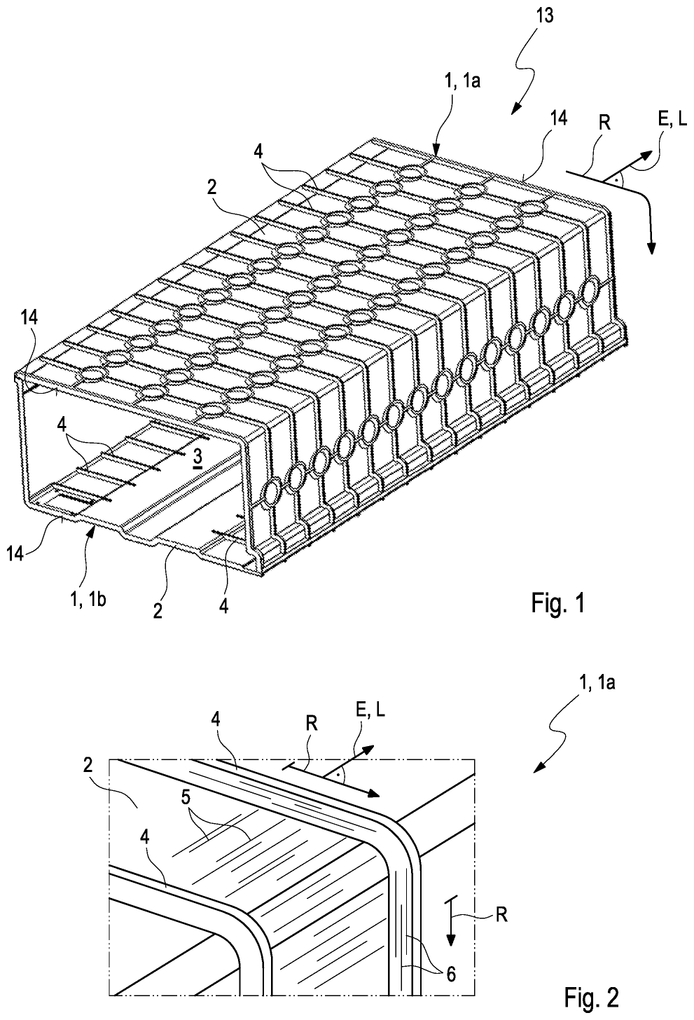

FIG. 2 shows a detail of the example of FIG. 1,

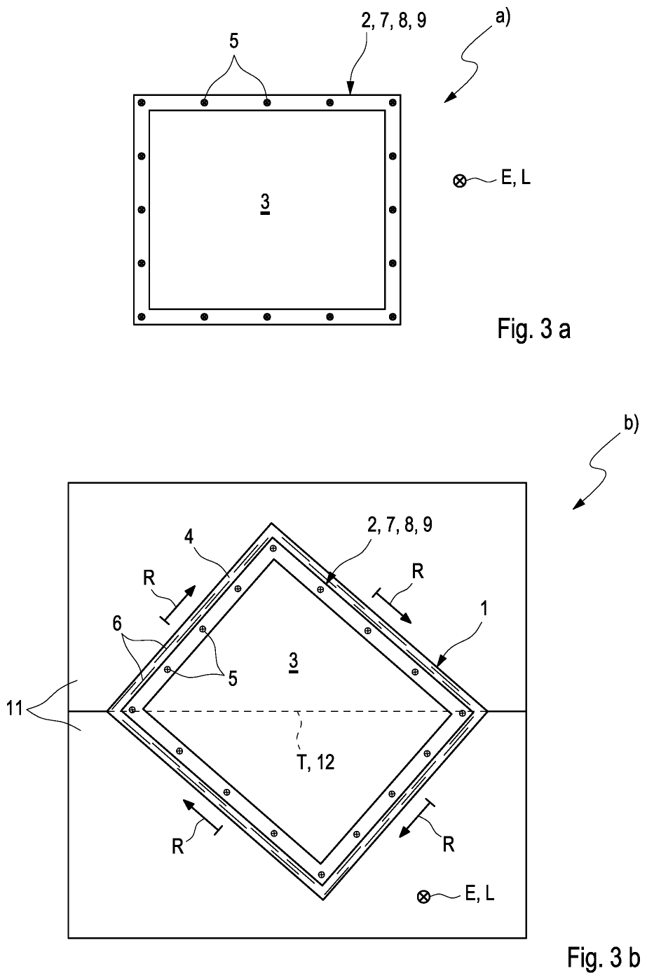

FIG. 3a shows, by way of example, a basic body, in a section perpendicular to a direction of extent, of a battery housing according to the invention in the manner of a snapshot when a method according to the invention for producing the battery housing is being carried out,

FIG. 3b shows, in a section perpendicular to the direction of extent, an example of a battery housing according to the invention in the manner of a snapshot when the method according to the invention for producing the battery housing is being carried out.

FIG. 1 shows a perspective illustration of an example of a battery housing 1 according to the invention for an electrical battery. Such an electrical battery may be part of a motor vehicle and serve in this respect for providing electrical energy or electrical power for an electric drive train of the motor vehicle. The battery housing 1 comprises a housing top part 1a and a housing bottom part 1b. Each of the two housing parts 1a, 1b of the battery housing 1 has a basic body 2 which extends in a direction of extent E. In the example shown, the direction of extent E corresponds to a longitudinal direction L, in which the basic bodies 2 of the battery housing 1 respectively extend. The basic bodies 2 at least partially delimit a housing interior space 3 on the inside. In the example shown, the two housing parts 1a, 1b thus together form a multi-part enclosure 13, which in addition to the housing parts 1a, 1b may comprise one or two caps—not shown in FIG. 1—which may be fastened to two end faces 14 of the battery housing 1 that are opposite one another in the direction of extent E, resulting in a fluid-tight sealing of the housing interior space 3 with respect to the external surroundings. The cap(s) may complete the two housing parts 1a, 1b to form the battery housing 1. The battery housing 1 comprises stiffening ribs 4, which are integrally shaped on the inside or the outside of the basic body 2 of the respective battery housing 1. These stiffening ribs 4, which are integrally shaped on the respective basic body 2, protrude from the basic body 2.

It can be seen in FIG. 1 that, in the case of the housing top part 1a, the respective stiffening ribs 4 are shaped integrally on the outside, that is to say facing away from the housing interior space 3, of the basic body 2. By contrast, in the case of the housing bottom part 1b the stiffening ribs 4 are shaped integrally on the inside, that is to say facing the housing interior space 3, of the basic body 2. The stiffening ribs 4 protruding from the basic body 2 run in a rib direction R on the basic body 2, the rib direction R being aligned at an angle to the direction of extent E of the basic body 2.

FIG. 2 shows a detail on an enlarged scale of the example according to the invention of a housing top part 1a of the battery housing 1 of FIG. 1. In this respect, FIG. 2 highly schematically illustrates that a body material of the basic body 2 comprises first reinforcing fibres 5. These first reinforcing fibres 5 of the body material of the basic body 2 run substantially in the direction of extent E of the basic body 2. A rib material of the stiffening rib 4 comprises second reinforcing fibres 6. The second reinforcing fibres 6 of the rib material of the stiffening rib 4 run substantially in the rib direction R. Since the direction of extent E and the rib direction R are oriented at an angle to one another, the first reinforcing fibres 5 of the body material of the basic body 2 and the second reinforcing fibres 6 of the rib material of the reinforcing rib 4 likewise run at an angle to one another. In the example shown, the rib direction R runs perpendicular to the direction of extent E. This means that the first reinforcing fibres 5 of the body material of the basic body 2 run substantially perpendicular to the second reinforcing fibres 6 of the rib material of the stiffening rib 4.

It can also be derived from the example of FIGS. 1 and 2 that the battery housing 1 comprises not only a single stiffening rib, but a plurality of stiffening ribs 4. These stiffening ribs 4 have a substantially similar form. The stiffening ribs 4 of the battery housing 1 are integrally shaped on the inside and/or outside of the basic body 2 in a manner spaced apart from one another. It goes without saying that stiffening ribs 4 can be integrally shaped both on the inside and on the outside of the basic body 2. The body material of the basic body 2 comprises a plastic matrix in which the first fibres 5 are embedded. The rib material of the stiffening rib 4 comprises a second plastic matrix in which the second fibres 6 are embedded. The first plastic matrix of the body material and the second plastic matrix of the rib material may be formed from the same plastic, a similar plastic or a different plastic. The first plastic matrix comprises a thermoplastic or consists of a thermoplastic. As an alternative or in addition, the second plastic matrix comprises a thermoplastic or consists of a thermoplastic. The first fibres 5 of the body material of the basic body 2 comprise glass fibres or carbon fibres or consist of glass fibres or carbon fibres. As an alternative or in addition, the second fibres 6 of the rib material of the stiffening rib 4 comprise glass fibres or carbon fibres or consist of glass fibres or carbon fibres.

The first fibres 5 have a fibre length of 0.05 mm to 10 mm, for example of 10 mm to 100 mm, measured in the direction of extent E. The second fibres 6 have a fibre length of 0.1 mm to 0.9 mm, measured in the rib direction R. The first fibres 5 have a diameter of 9 μm to 15 μm, measured perpendicular to the direction of extent E. The second fibres 6 have a diameter of 9 μm to 15 μm, measured perpendicular to the rib direction R.

FIG. 3b shows, in a section perpendicular to the direction of extent E, a further example according to the invention of the battery housing 1 in the manner of a snapshot when a method according to the invention for producing the battery housing 1 is being carried out. It can be seen here that the basic body 2 of the battery housing 1 completely surrounds the housing interior space 3 in the section 9 perpendicular to the direction of extent E. In this respect, the at least one stiffening rib 4 is shaped around the complete periphery of the basic body 2 in the section 9. The basic body 2 has a profile 7 which is extruded in the direction of extent E. In the example shown, the basic body 2 has a rectangular hollow profile 8 which is extruded in the direction of extent E.

FIG. 3a shows, in the manner of a snapshot in a section perpendicular to the direction of extent E, a basic body 2 for a battery housing 1 according to the invention when the method according to the invention for producing the battery housing 1 is being carried out. Said method comprises a measure a), in which a body raw material comprising first fibres 5 is extruded in a direction of extent E. In the example shown, the direction of extent E corresponds to a longitudinal direction L along which the body raw material is extruded. This extrusion may take place by means of pultrusion. In this case, the body raw material according to measure a) is extruded in the direction of extent E or longitudinal direction L in such a way that a basic body 2 of the battery housing 1 that extends in the direction of extent E or longitudinal direction L is created. The basic body 2 of the battery housing 1 that was created in measure a) at least partially delimits a housing interior space 3 of the battery housing 1.

In the snapshot shown in FIG. 3b, when the method for producing the battery housing 1 is being carried out, a further measure b) of the method is also illustrated. According to this measure b) of the method, a rib raw material comprising second fibres 6 is moulded onto the basic body 2. The rib raw material is moulded onto the basic body 2 in measure b) in such a way that at least one stiffening rib 4 which runs in the rib direction R oriented at an angle to the direction of extent E is integrally shaped on the inside or the outside of the basic body 2. In the example shown, the stiffening rib 4 is integrally shaped on the outside of the basic body 2. In this case, the stiffening rib 4 may be connected in a materially bonded and/or form-fitting manner to the basic body 2.

It can moreover be seen in FIGS. 3a and 3b that, in measure a), the first fibres 5 are aligned substantially in the direction of extent E during the extrusion of the body raw material. Here, in measure a), the first fibres 5 are aligned in the direction of extent E when the body raw material is being extruded in such a way that the first fibres 5 in a body material of the basic body 2 that comprises the first fibres 5—after the extrusion according to measure a)—are arranged running substantially in the direction of extent E. It is moreover shown that, in measure b), the second fibres 6 are aligned substantially in the rib direction R when the rib raw material is being moulded on. Here, in measure b), the second fibres 6 are aligned in the rib direction R when the rib raw material is being moulded on in such a way that the second fibres 6 in a rib material of the stiffening rib 4 that comprises the second fibres 6—after the moulding on according to measure b)—are arranged running substantially in the rib direction R.

FIG. 3b additionally shows that the stiffening rib 4 is moulded on according to measure b) for example in an injection mould 11, in which the basic body 2 of the battery housing 1 that was created in measure a) is placed at a time before carrying out measure b). The basic body 2 of the battery housing 1 that was created in measure a) has a rectangular hollow profile 8 which is extruded in the direction of extent E. In this respect, a parting plane T of the injection mould 11, in which the stiffening rib 4 is moulded on according to measure b), is determined by a diagonal 12 of the rectangular hollow profile 8. Here, in measure b), a plurality of stiffening ribs 4, which for example are arranged spaced apart from one another in the direction of extent E, may be shaped on the inside and/or outside of the basic body 2.

In measure b), in addition to the moulding on of the ribs 4, it is also possible for the housing interior space 3 of the battery housing 1 to be closed in a fluid-tight manner in the direction of extent E of one end by moulding on a cover in the region of one of the end faces 14. This means that, after carrying out measure b), the housing interior space 3 remains in fluidic communication with the external surroundings only via a single opening on the end face of the battery housing 1, which opening is opposite the moulded-on cover with respect to the direction of extent. This remaining opening can be closed by means of a cap which can be fastened to the battery housing 1, it being possible for any housing-side fastening geometries, such as a sealing flange, screwing points, or the like, which are required for this purpose to be created likewise in measure b). The cover and cap are not shown in the figures for reasons of clarity.

1. Battery housing (1) for an electrical battery, in particular for a motor vehicle,
having a basic body (2) which extends in a direction of extent (E), in particular a longitudinal direction (L), and at least partially delimits a housing interior space (3) on the inside,
having at least one stiffening rib (4), which is integrally shaped on the inside or the outside of the basic body (2), protrudes from the basic body (2) and extends on the basic body (2) in a rib direction (R) oriented at an angle to the direction of extent (E),
wherein a body material of the basic body (2) comprises first reinforcing fibres (5), which run substantially in the direction of extent (E),
wherein a rib material of the stiffening rib (4) comprises second reinforcing fibres (6), which run substantially in the rib direction (R).

2. Battery housing (1) according to claim 1,
characterized in that
the rib direction (R) runs perpendicular to the direction of extent (E).

3. Battery housing (1) according to claim 1 or 2,
characterized in that
the battery housing (1) comprises a plurality of stiffening ribs (4), which are integrally shaped on the basic body (2) in a manner respectively spaced apart from one another.

4. Battery housing (1) according to one of claims 1 to 3,
characterized in that
the body material comprises a first plastic matrix, in which the first fibres (5) are embedded; and/or in that
the rib material comprises a second plastic matrix, in which the second fibres (6) are embedded,
wherein the first and the second plastic matrix comprise a respective plastic, preferably the same plastic.

5. Battery housing (1) according to claim 4,
characterized in that
the first and/or the second plastic matrix comprises a thermoplastic or consists of a thermoplastic.

6. Battery housing according to one of the preceding claims,
characterized in that
the first fibres (5) comprise glass fibres or carbon fibres or consist of glass fibres or carbon fibres; and/or in that
the second fibres (6) comprise glass fibres or carbon fibres or consist of glass fibres or carbon fibres.

7. Battery housing (1) according to one of the preceding claims,
characterized in that
the first fibres (5) respectively have a fibre length of 0.05 mm to 100 mm, preferably of 1 mm to 10 mm, most preferably of 10 mm to 100 mm, measured in the direction of extent (E); and/or in that
the second fibres (6) respectively have a fibre length of 0.1 mm to 0.9 mm, measured in the rib direction (R).

8. Battery housing (1) according to one of the preceding claims,
characterized in that
the first fibres (5) have a diameter of 9 μm to 15 μm, measured perpendicular to the direction of extent (E); and/or in that
the second fibres (6) have a diameter of 9 μm to 15 μm, measured perpendicular to the rib direction (R).

9. Battery housing (1) according to one of the preceding claims,
characterized in that
the basic body (2) completely surrounds the housing interior space (3) in a section (9) perpendicular to the direction of extent (E),
wherein the stiffening rib (4) is shaped preferably around the complete periphery of the basic body (2) in the section (9) perpendicular to the direction of extent (E).

10. Battery housing (1) according to one of the preceding claims,
characterized in that
the basic body (2) has a profile (7), in particular a rectangular hollow profile (8), which is extruded in the direction of extent (E).

11. Method for producing a battery housing (1), in particular according to one of the preceding claims,
comprising the following measures:
a) extruding a body raw material comprising first fibres (5) in a direction of extent (E), in particular a longitudinal direction (L), with the result that a basic body (2) of the battery housing (1) that extends in the direction of extent (E) or longitudinal direction (L) is created, which basic body at least partially delimits a housing interior space (3) of the battery housing (1) on the inside,
b) moulding a rib raw material comprising second fibres (6) onto the basic body (2), with the result that at least one stiffening rib (4) running in a rib direction (R) which is oriented at an angle to the direction of extent (E) is integrally shaped on the inside or the outside of the basic body (2).

12. Method according to claim 11,
characterized in that,
in measure a), the first fibres (5) are aligned substantially in the direction of extent (E) when the body raw material is being extruded, with the result that the first fibres (5) in a body material of the basic body (2) that comprises the first fibres (5) are arranged running in the direction of extent (E),
in measure b), the second fibres (6) are aligned substantially in the rib direction (R) when the rib raw material is being moulded on, with the result that the second fibres (6) in a rib material of the stiffening rib (4) that comprises the second fibres (6) are arranged running substantially in the rib direction (R).

13. Method according to claim 11 or 12,
characterized in that
the stiffening ribs (4) are moulded on according to measure b) in an injection mould (11), in which the basic body (2) that was created in measure a) is placed at a time before carrying out measure b).

14. Method according to claim 13,
characterized in that
the basic body (2) that was created in measure a) has a rectangular hollow profile (8) which is extruded in the direction of extent (E),
a parting plane (T) of the injection mould (11), in which the stiffening rib (4) is moulded on according to measure b), is determined by a diagonal (12) of the rectangular hollow profile (8).

15. Method according to one of claims 11 to 14,
characterized in that,
in measure b), a plurality of stiffening ribs (4) are shaped on the inside and/or the outside of the basic body (2), in particular in a manner spaced apart from one another in the direction of extent (E).
